(19) United States
(12) Patent Application Publication
(10) Pub. No.: US 2007/0196413 A1
(43) Pub. Date: Aug. 23, 2007

(54) Surfactant enhanced quick release pesticide granules

(75) Inventors: Alan J. Stern, Round Rock, TX (US); Christopher J. Whewell, Georgetown, TX (US)

Correspondence Address: HUNTSMAN PETROCHEMICAL CORPORATION, LEGAL DEPARTMENT, 10003 WOODLOCH FOREST DRIVE, THE WOODLANDS, TX, 77380, US

(73) Assignee: Huntsman Petrochemical Corporation, The Woodlands, TX (US)

(21) Appl. No.: 10/582,156

(22) PCT Filed: Dec. 6, 2004
(86) PCT No.: PCT/US04/40731

§ 371 Date: Jun. 8, 2006

Related U.S. Application Data
(60) Provisional application No. 60/530,586, filed on Dec. 18, 2003.

(51) Int. Cl. A01N 25/26

(52) U.S. Cl. 424/417; 514/783

(57) ABSTRACT

Provided herein are granular carriers which are impregnated with an agriculturally active ingredient and a surfactant. The compositions of the invention provide increased efficacy over granules of the prior art.

### CROSS REFERENCES TO RELATED APPLICATIONS

This application claims the benefit of U.S. Provisional Application No. 60/530,586 filed Dec. 18, 2003 which is currently still pending.

### FIELD OF THE INVENTION

The invention relates generally to pesticide compositions, and more particularly to insecticides which are bound to a solid inert carrier, wherein the carrier containing the pesticide is applied to an area to be treated.

### DESCRIPTION OF THE RELATED ART

It is known that compositions containing pyrethroid insecticides, such as bifenthrin and permethrin, disposed on an inert carrier often do not possess acceptable efficacy when they are formulated as broadcast granules on BIODAC® (available from GranTek Inc., Granger, Ind. 46530) as a carrier as compared with cases where other granular carriers such as peanut hulls, ground corn cobs and other inerts are used. It seems from what I have observed that the pyrethroids as a class bind tightly to the BIODAC® inorganic/organic matrix, and upon application to soil, the pyrethrins are only released slowly and/or incompletely, thus providing a lower than desired level of active chemical per area, and hence reduced efficacy and effectiveness. However, because BIODAC® granules have certain advantages over other inert carriers, it would be advantageous to overcome its limitations associated with poor release characteristics relative to insecticide binding.

I have found that the presence of a surfactant (at a level of surfactant of between about 4 to about 12% by weight based on the total weight of the final supported product) on BIODAC® granules along with bifenthrin or permethrin greatly enhances its insecticidal activity compared to the analogous composition of BIODAC® granules combined with pyrethrin without surfactant. This effect is extensible to all pesticides.

Agricultural sprayable formulations which contain surfactants are well known. In such formulations, surfactants wet and disperse particles of active ingredient(s) in the concentrate or upon dilution prior to spraying, and wet the target surface with the pesticide spray to achieve more effective coverage of the target. The prior art contains some instances where a surfactant is included in a granular composition that is intended to be applied in its dry, granular state. For example, U.S. Pat. No. 5,750,130 which discloses how to make an abrasion-resistant granule through the use of a molten coating material such as a wax. It also discusses the use of “wax soluble surfactants” to control or reduce the release rate of a pesticide from a matrix of wax, pesticide, inert carrier. U.S. Pat. No. 6,004,904 provides a method for the selective control of an unwanted turfgrass or weed species in the presence of a desired turfgrass species at a turfgrass locus, wherein the method comprises applying to the turfgrass locus a herbicidally effective amount of an isoxazole compound.

According to the present invention, the presence of surfactant(s) causes the efficacy of granular pesticides comprising one or more pyrethroids disposed on BIODAC® granules to be greatly improved due to accelerated release of the active pesticide to the surrounding environment. Once released from its inert granular carrier, the insecticide is available to exert its desired effect, such as the killing of insects. Thus, granules according to one preferred form of the present invention contain an insecticide, a cellulose based carrier, and a surfactant.

### BRIEF SUMMARY OF THE INVENTION

One object of the present invention is to provide an acceptably efficacious supported bifenthrin formulation designed to be used as a “broadcast granule”. Previously, bifenthrin, when formulated on BIODAC® granules was not nearly as effective at killing undesirable insects as bifenthrin in other formulations, and it is believed that bifenthrin has an unusual affinity for the BIODAC® granule matrix. Because it is tightly bound within the granule matrix, it does not want to leave the granule and enter the environment where it must be to be effective.

It has been found that certain surfactants will overcome the affinity/binding of bifenthrin to the inert carrier BIODAC®. Thus, incorporating an effective bifenthrin-freeing amount of surfactant to the granular formulation enhances the activity to acceptable levels.

I have found that by adding about 5-15% surfactant to the granules along with about 0.05-0.5% pyrethroid insecticide the activity of the pyrethroid is restored to acceptable levels. I have also found the strange fact that if an equivalent amount (on a weight basis) of an organic fluid is substituted for the surfactant, the insecticidal activity of the formulation is reduced. I have identified non-ionic surfactants as the preferred type of surfactant useful in combination with pyrethroid insecticides on BIODAC® granules, yielding an acceptably-efficacious insecticide formulation. Especially useful non-ionic surfactants include alcohol ethoxylates, fatty amine ethoxylates, polyglycol fatty acid esters, and allylphenol ethoxylates, including nonylphenol ethoxylates, and other surfactants.

### DETAILED DESCRIPTION OF THE INVENTION

The invention is preferably carried out by dissolving an active pesticidal material (in one case, bifenthrin, or a bifenthrin manufacturing use product (“MUP”)) in a suitable surfactant falling within one of the aforesaid classes, or any other surfactant. Preferred surfactants are those which are liquid at ambient temperature because of the ease of handling. However, the present invention may employ surfactants which are solid at ambient conditions, dissolved or dispersed in a suitable organic solvent, or water. Thus, all water-soluble or dispersible surfactants are useful in providing a pesticide granule according to the invention.

Other surfactants and materials which may be used in combination with an agriculturally-active material and a cellulosic carrier according to the invention include amphoteric/zwitterionic surfactants; anionic surfactants; nonionic surfactants; cationic surfactants; and optional ingredients.

Amphoteric surfactants useful in the invention can be described as a surface active agent containing at least one anionic and one cationic group and can act as either acids or bases depending on pH. Some of these compounds are aliphatic derivatives of heterocyclic secondary and tertiary amines in which the aliphatic radical may be straight or branched and wherein one of the aliphatic substituents contains from about 6 to about 20, preferably 8 to 18, carbon atoms and at least one contains an anionic water-solubilizing group, e.g., carboxy, phosphonate, phosphate, sulfonate, sulfate.

Zwitterionic surfactants can be described as surface active agents having a positive and negative charge in the same molecule which molecule is zwitterionic at all pH's. Zwitterionic surfactants can be best illustrated by betaines and sultaines. The zwitterionic compounds generally contain a quaternary ammonium, quaternary phosphonium or a tertiary sulfonium moiety. The cationic atom in the quaternary compound can be part of a heterocyclic ring. In all of these compounds there is at least one aliphatic group, straight chain or branched, containing from about 6 to 20, preferably 8 to 18, carbon atoms and at least one aliphatic substituent containing an anionic water-solubilizing group, e.g., carboxy, sulfonate, sulfate, phosphate or phosphonate.

Examples of suitable amphoteric and zwitterionic surfactants include the alkali metal, alkaline earth metal, ammonium or substituted ammonium salts of alkyl amphocarboxyglycinates and alkyl amphocarboxypropionates, alkyl amphodipropionates, alkyl monoacetate, alkyl diacetates, alkyl amphoglycinates, and alkyl amphopropionates wherein alkyl represents an alkyl group having from 6 to about 20 carbon atoms. Other suitable surfactants include alkyliminomonoacetates, alkyliminidiacetates, alkyliminopropionates, alkyliminidipropionates, and alkylamphopropylsulfonates having between 12 and 18 carbon atoms, alkyl betaines and alkylamidoalkylene betaines and alklyl sultaines and alkylamidoalkylenehydroxy sulfonates.

Anionic surfactants which may be used in the present invention are those surfactant compounds which contain a long chain hydrocarbon hydrophobic group in their molecular structure and a hydrophilic group, including salts such as carboxylate, sulfonate, sulfate or phosphate groups. The salts may be sodium, potassium, calcium, magnesium, barium, iron, ammonium and amine salts of such surfactants.

Anionic surfactants include the alkali metal, ammonium and alkanol ammonium salts of organic sulfuric reaction products having in their molecular structure an alkyl, or alkaryl group containing from 8 to 22 carbon atoms and a sulfonic or sulfuric acid ester group.

Examples of such anionic surfactants include water soluble salts and mixtures of salts of alkyl benzene sulfonates having between 8 and 22 carbon atoms in the allyl group, alkyl ether sulfates having between about 8 and about 22 carbon atoms in the alkyl group and about 2 to about 9 moles ethylene oxide in the ether group. Other anionic surfactants that can be mentioned include alkyl sulfosuccinates, alkyl ether sulfosuccinates, olefin sulfonates, alkyl sarcosinates, alkyl monoglyceride sulfates and ether sulfates, alkyl ether carboxylates, paraffinic sulfonates, mono and dialkyl phosphate esters and ethoxylated derivatives, acyl methyl taurates, fatty acid soaps, collagen hydrosylate derivatives, sulfoacetates, acyl lactates, aryloxide disulfonates, sulfosuccinamides, naphthalene-formaldehyde condensates and the like. Aryl groups generally include one and two rings, alkyl generally includes from 8 to 22 carbon atoms and the ether groups generally range from 1 to 9 moles of ethylene oxide (EO) and/or propylene oxide (PO), preferably EO.

Specific anionic surfactants which may be selected include linear alkyl benzene sulfonates such as decylbenzene sulfonate, undecylbenzene sulfonate, dodecylbenzene sulfonate, tridecylbenzene sulfonate, nonylbenzene sulfate and the sodium, potassium, ammonium, triethanol ammonium and isopropyl ammonium salts thereof.

The nonionic surfactant(s) is not critical and may be any of the known nonionic surfactants which are generally selected on the basis of compatibility, effectiveness and economy.

Examples of useful nonionic surfactants include condensates of ethylene oxide with a hydrophobic moiety which has an average hydrophilic lipophilic balance ([L3) between about 4 to about 14, and preferably between about 7.5 and about 12.5. The surfactants include the ethoxylated primary or secondary aliphatic alcohols having from about 8 to about 24 carbon atoms, in either straight or branch chain configuration, with from about 2 to about 40, and preferably between about 2 and about 9 moles of ethylene oxide per mole of alcohol.

Other suitable nonionic surfactants include the condensation products of from about 6 to about 12 carbon atoms alkyl phenols with about 3 to about 30, and preferably between about 5 to about 14 moles of ethylene oxide.

Many cationic surfactants are known in the art and almost any cationic surfactant having at least one long chain allyl group of about 10 to 24 carbon atoms is suitable for optional use in the present invention.

The optional ingredients and optional surfactants can be added to the agriculturally-active material before, during or after its admixture with the cellulosic carrier.

### Agriculturally Active Materials

As used in this specification and the appended claims, the words “agriculturally active material” means any chemical substance that: 1) when applied to a given foliage that is generally regarded as undesirable adversely affects the longevity and/or reproductive capability of such foliage; or 2) when applied to the vicinity where insects dwell adversely affects the longevity and/or reproductive capability of such insects; or 3) is regarded by those skilled in the art as possessing pesticidal (including either insecticidal or herbicidal) and/or fungicidal properties. Include within this definition, without limitation, are those chemical materials such as: 2,4,5-T, Acephate, Acetamiprid, Acrinathrin, Aldicarb, Amitraz, Amitrole, Arsenic and its compounds, Bendiocarb, Benfuresate, Bensulfuron methyl, Bentazone, BHC, 2,4-D Bitertanol, Butamifos, Butylate, Cadusafos, Captafol(Difolatan), Captan, Carbaryl, Chinomethionat, Chlorfenvinphos, Chlorfluazuron, Chlorimuron ethyl, Chlormequat, Chlorobenzilate, Chlorpropham, Chlorpyrifos, Cinmethylin, Clofentezine, Copper terephthalate trihydrate, Cyanide compounds, Cyfluthrin, Cyhalothlin, Cyhexatin, Cypermethrin, Cyproconazole, Cyromazine, Daminozide, DCIP, DDT(including DDD,DDE), Deltamethrin, Demeton, Diazinon, Dicamba, Dichlofluanid, Dichlorvos, Diclomezine, Dicofol(Kelthane), Dieldrin( including Aldrin), Diethofencarb, Difenoconazole, Difenzoquat, Diflubenzuron, Dimethipin, Dimethoate, Dimethylvinphos, Edifenphos, Endrin, EPN, EPTC, Esprocarb, Ethiofencarb, Ethofenprox, Ethoprophos, Ethoxyquin, Etobenzanide, Etrimfos, Fenarimol, Fenbutatin oxide, Fenitrothion, Fenobucarb, Fenpyroximate, Fensulfothion, Fenthion, Fenvalerate, Flucythrinate, Flufenoxuron, Fluoroimide, Flusilazole, Flusulfamide, Flutolanil, Fluvalinate, Fosetyl, Fosthiazate, Glufosinate, Glyphosate, Guthion, Halfenprox, Heptachlor( including Heptachlor epoxide), Hexaflumuron, Hexythiazox, Imazalil, Imazosulfulron, Imibenconazole, Iminoctadine, Inabenfide, Inorganic bromide, Iprodione, Isophenphos, Isoprocarb, Lead & its compounds, Lenacil, Malathion, Maleic hydrazide, MCPA (including Phenothiol), Mepanipyrim, Mephenacet, Mepronil, Methamidophos, Methiocarb, Methoprene, Methoxychlor, Metolachlor, Metribuzin, Mirex, Myclobutanil, Nitenpyram, Oxamyl, Paclobutrazol, Parathion, Parathion-methyl, Pencycuron, Pendimethalin, Permethrin, Phenthoate, Phosalone(Rubitox), Phoxim, Picloram, Pirimicarb, Pirimiphos-methyl, Pretilachlor, Prohexadione, Propamocarb, Propiconazole, Prothiofos, Pyraclofos, Pyrazoxyfen, Pyrethrins, Pyridaben, Pyridate, Pyrifenox, Pyrimidifen, Pyriproxyfen, Quinalphos, Quinclorac, Sethoxydim, Silafluofen, Tebuconazole, Tebufenozide, Tebufenpyrad, Tecloftalam, Tefluthrin, Terbufos, Thenylchlor, Thiobencarb, Thiometon, Tralomethrin, Triadimenol, Tribenuron methyl, Trichiamide, Trichlorfon, Triclofos-methyl, Tricyclazole, Triflumizole, and Vamidothion.

### Agricultural Adjuvants

Adjuvants are chemical materials which are often employed as a component of an agriculturally active material, and which are designed to perform specific functions, including wetting, spreading, sticking, reducing evaporation, reducing volatilization, buffering, emulsifying, dispersing, reducing spray drift, and reducing foaming. No single adjuvant can perform all these functions, but different compatible adjuvants often can be combined to perform multiple functions simultaneously; thus, adjuvants are a diverse group of chemical materials. Within the meaning of the term “Adjuvants” is included any substance added to a spray tank to modify a pesticide's performance, the physical properties of the spray mixture, or both.

Spray application is perhaps the weakest link in the chain of events a pesticide follows through its development process. Some researchers claim that up to 70 percent of the effectiveness of a pesticide depends on the effectiveness of the spray application. Selection of a proper adjuvant may reduce or even eliminate spray application problems associated with pesticide stability, solubility, incompatibility, suspension, foaming, drift, evaporation, volatilization, degradation, adherence, penetration, surface tension, and coverage, thereby improving overall pesticide efficiency and efficacy.

Surfactant adjuvants physically alter the surface tension of a spray droplet. For a pesticide to perform its function properly, a spray droplet must be able to wet the foliage and spread out evenly over a leaf. Surfactants enlarge the area of pesticide coverage, thereby increasing the pest's exposure to the chemical. Without proper wetting and spreading, spray droplets often run off or fail to adequately cover these surfaces. Such materials enhance the absorbing, emulsifying, dispersing, spreading, sticking, wetting or penetrating properties of pesticides. Surfactants are most often used with herbicides to help a pesticide spread over and penetrate the waxy outer layer of a leaf or to penetrate through the small hairs present on a leaf surface.

While surfactant adjuvants may be anionic, cationic, or non-ionic, the non-ionic surfactants are in most common usage. The “multi-purpose” non-ionic surfactants are composed of alcohols and fatty acids, have no electrical charge and are compatible with most pesticides. Certain other surfactants may be cationic (+ charge) or anionic (− charge) and are specialty adjuvants that are used in certain situations and with certain products. Anionic surfactants are mostly used with acids or salts, and are more specialized and used as dispersants and compatibility agents. Cationic surfactants are used less frequently but one group, the ethoxylated fatty amines, sometimes are used with the herbicide glyphosate.

Silicone-based surfactants are increasing in popularity due to their superior spreading ability. Some of these surfactants are a blend of non-ionic surfactants (NIS) and silicone while others are entirely a silicone. The combination of a NIS and a silicone surfactant can increase absorption into a plant so that the time between application and rainfall can be shortened. There are generally two types of organo-silicone surfactants: the polyether-silicones that are soluble in water and the alkyl-silicones that are soluble in oil. Unlike polyether-silicone types, alkyl-silicone surfactants work well with oil-based sprays, such as dormant and summer oil sprays used in insect control. Alkyl-silicone-enhanced oil sprays can maximize insecticidal activity and even allow significantly lower pesticide use rates that reduce residue levels on crops.

Sticker adjuvants increase the adhesion of solid particles to target surfaces. These adjuvants can decrease the amount of pesticide that washes off during irrigation or rain. Stickers also can reduce evaporation of the pesticide and some slow ultraviolet (UV) degradation of pesticides. Many adjuvants are formulated as spreader-stickers to make a general purpose product that includes a wetting agent and an adhesive.

Extender adjuvants function like sticker surfactants by retaining pesticides longer on the target area, slowing volatilization, and inhibiting UV degradation.

Plant penetrant surfactants have a molecular configuration that enhances penetration of some pesticides into plants. A surfactant of this type may increase penetration of a pesticide on one species of plant but not another. Systemic herbicides, auxin-type herbicides, and some translocatable fungicides can have their activity increased as a result of enhanced penetration.

Compatibility agent adjuvants are especially useful when pesticides are combined with liquid fertilizers or other pesticides, particularly when the combinations are physically or chemically incompatible, such as in cases when clumps and/or uneven distribution occurs in the spray tank. A compatibility agent may eliminate problems associated with such situations.

Buffers or pH modifier adjuvants are generally employed to prevent problems associated with alkaline hydrolysis of pesticides that are encountered when the pH of a pesticide exceeds about 7.0 by stabilizing the pH at a relatively constant level. Extreme pH levels in the spray mixture can cause some pesticides to break down prematurely. This is particularly true for the organophosphate insecticides but some herbicides can break down into inactive compounds in a matter of hours or minutes in alkaline situations (pH>7). For example, the insecticide Cygon (dimethoate) loses 50 percent of its pest control power in just 48 minutes when mixed in water of pH 9. At a pH of 6, however, it takes 12 hours for degradation to progress to that extent. On the other hand, sulfonyl urea (SU) herbicides tend to break down more rapidly where the pH is below 7. At low pHs, the herbicide 2,4-D is an uncharged molecule. At higher pH, 2,4-D tends to become more anionic or negatively charged which can affect its movement in the environment. Leaf coatings often have a high pH that can contribute to poor performance with certain herbicides. The use of a buffering or acidifying adjuvant can stabilize or lower the pH of a spray solution thereby improving the stability of the pesticide being used.

Mineral control adjuvants are used to mask the problems associated with water hardness minerals in spray water which can diminish the effectiveness of many pesticides. Mineral ions such as calcium, magnesium, salts and carbonates are commonly found in hard water. These ions can bind with the active ingredients of some pesticides, especially the salt-formulation herbicides such as Roundup™ (glyphosate), Poast™ (sethoxydim), Pursuit™ (imazethapyr), and Liberty™ (glufosinate) resulting in poor weed control. The use of water-conditioning adjuvants gives hard water minerals something to bind with other than the herbicide. In addition, some ammonium sulfate-based adjuvants can be used to offset hard water problems.

Drift retardant adjuvants improve on-target placement of pesticide spray by increasing the average droplet size, since drift is a function of droplet size with drops with diameters of 100 microns or less tending to drift away from targeted areas.

Defoaming agent adjuvants are used to control the foam or frothy head often present in some spray tanks that results from the surfactant used and the type of spray tank agitation system can often can be reduced or eliminated by adding a small amount of foam inhibitor.

Thickener adjuvants increase the viscosity of spray mixtures which afford control over drift or slow evaporation after the spray has been deposited on the target area.

Oil-based adjuvants have been gaining in popularity especially for the control of grassy weeds. There are three types of oil-based adjuvants: crop oils, crop oil concentrates (COC) and the vegetable oils. Crop Oil adjuvants are derivative of paraffin-based petroleum oil. Crop oils are generally 95-98% oil with 1 to 2% surfactant/emulsifier. Crop oils promote the penetration of a pesticide spray either through a waxy plant cuticle or through the tough chitinous shell of insects. Crop oils may also be important in helping solubilize less water-soluble herbicides such as Poast™ (sethoxydim), Fusilade™ (fluaziprop-butyl) and atrazine. Traditional crop oils are more commonly used in insect and disease control than with herbicides. Crop oil concentrates (COC) are a blend of crop oils (80-85%) and the non-ionic surfactants (15-20%.). The purpose of the non-ionic surfactant in this mixture is to emulsify the oil in the spray solution and lower the surface tension of the overall spray solution. Vegetable oils work best when their lipophilic characteristics are enhanced, and one common method of achieving this is by esterification of common seed oils such as rapeseed, soybean, and cotton. The methylated seed oils (MSO) are comparable in performance to the crop oil concentrates, in that they increase penetration of the pesticide. In addition, silicone-based MSOs are also available that take advantage of the spreading ability of the silicones and the penetrating characteristics of the MSOs.

The special purpose or utility adjuvants are used to offset or correct certain conditions associated with mixing and application such as impurities in the spray solution, extreme pH levels, drift, and compatibility problems between pesticides and liquid fertilizers. These adjuvants include acidifiers, buffering agents, water conditioners, anti-foaming agents, compatibility agents, and drift control agents.

Fertilizer-based adjuvants, particularly nitrogen-based liquid fertilizers, have been frequently added to spray solutions to increase herbicide activity. Research has shown that the addition of ammonium sulfate to spray mixtures enhances herbicidal activity on a number of hard-to-kill broadleaf weeds. Fertilizers containing ammonium nitrogen have increased the effectiveness of the certain polar, weak acid herbicides such as Accent™ (nicosulfuron), Banvel™ (dicamba), Blazer™ (acifluorfen-sodium), Roundup™ (glyphosate), Basagran™ (bentazon), Poast™ (sethoxydim), Pursuit™ (imazethapyr), and 2,4-D amine. Early fertilizer-based adjuvants consisted of dry (spray-grade) ammonium sulfate (AMS) at 17 lbs per 100 gallons of spray volume (2%). Studies of these adjuvants has shown that Roundup™ uptake was most pronounced when spray water contained relatively large quantities of certain hard water ions, such as calcium, sodium, and magnesium. It is thought that the ions in the fertilizer tied up the hard water ions thereby enhancing herbicidal action.

Thus, the words “agricultural adjuvant” when used in this specification and the appended claims means any material recognized by those skilled in the art of pesticides to be useful as an adjuvant material in connection with the formulation and/or use of a pesticide, and include all materials falling within the specific classes outlined above.

Minor amounts of organic solvents may be used to increase the fluidity of the surfactant/pyrethrin solution to ease the process of making the granules. In one embodiment of the invention, after preparing the solution of pyrethrin/surfactant, it is added to the BIODAC® granules while tumbling the granules in a mixer. It is important to evenly distribute the solution during this process so that each granule absorbs as close to about the same amount of surfactant/pyrethrin solution as all of the other granules. Mixing is continued until all the liquid has been absorbed by the granules. Preferably, the final composition contains less than 15% liquid, but at least 5% surfactant. These percentages are by weight based upon the total weight of the finished granules. The relative amounts of pyrethrin, surfactant, and solvent (if any) may be adjusted to achieve the desired level of active ingredient and ease of processing.

Although methods have been described relative to pyrethroid insecticides and BIODAC® granules in combination with particular surfactants, these methods are applicable to a wide range of surfactants and agriculturally active materials. Unless specified otherwise all parts and percentages in this specification are expressed as parts by weight.

### Compositions and Test Results

16 granular formulations were prepared that contained 0.1% bifenthrin (0.77% of a M-UP containing 13% bifenthrin) and various combinations of surfactant and/or inert organic diluent. Each granule formulation contained 88% BIODAC® 12/20 granules, 0.77% bifenthrin MUP, and 11.23% total surfactants/solvents. Testing of the formulations showed that the greatest insect control was provided by the granule formulations containing 6% or more surfactant. Several of the formulations performed very well in lab and field tests. Formulations that did not perform well in lab and field tests were those that contained little or no surfactant such as examples 1, 2, 4, 5.

The tables I and II below specify several different formulations made using BIODAC® granules:

TABLE I

| | Example No. | | | | | | | |
|---|---|---|---|---|---|---|---|---|
| Ingredient | 1 | 2 | 3 | 4 | 5 | 6 | 7 | 8 |
| Talstar SFR MUP (13% bifenthrin) | 0.77 | 0.77 | 0.77 | 0.77 | 0.77 | 0.77 | 0.77 | 0.77 |
| BIODAC ® 12/20 granules | 88 | 88 | 88 | 88 | 88 | 88 | 88 | 88 |
| CARSPRAY ®300 dimethyl alkyl quat | 2.66 | 2.66 | 2.66 | 2.66 | 2.66 | 2.66 | 2.66 | 2.66 |
| Tall Oil Fatty Acid | 8.57 | — | — | — | — | — | — | — |
| Propylene glycol | — | 8.57 | — | — | — | — | — | — |
| SURFONIC ®L24-4 surfactant | — | — | 8.57 | — | — | — | — | — |
| EXXSOL ® D-110 solvent | — | — | — | 8.57 | — | — | — | — |
| Propylene carbonate | — | — | — | — | 8.57 | — | — | — |
| SURFONIC ® N-40 surfactant | — | — | — | — | — | 8.57 | — | — |
| SURFONIC ® T-6 surfactant | — | — | — | — | — | — | 8.57 | — |
| AROMATIC ® 200 solvent | — | — | — | — | — | — | — | 2.5 |
| SURFONIC ® N-120 surfactant | — | — | — | — | — | — | — | 6.07 |

TABLE II

| | Example No. | | | | | | | |
|---|---|---|---|---|---|---|---|---|
| Ingredient | 9 | 10 | 11 | 12 | 13 | 14 | 15 | 16 |
| TALSTAR ® SFR MUP (13% | 0.77 | 0.77 | 0.77 | 0.77 | 0.77 | 0.77 | 0.77 | 0.77 |
| bifenthrin) | | | | | | | | |
| BIODAC ® 12/20 granules | 88 | 88 | 88 | 88* | 88 | 88 | 88 | 88 |
| SURFONIC ® L24-4 surfactant | — | — | — | — | 11.23 | — | — | — |
| EXXSOL ® D-110 solvent | 8.57 | 8.57 | 8.57 | 11.23 | — | — | — | 8.57 |
| SURFONIC ® N-40 surfactant | — | — | — | — | — | 11.23 | — | — |
| SURFONIC ® T-6 surfactant | — | 2.66 | — | — | — | — | 11.23 | — |
| VAROSOFT ®222 surfactant | 2.66 | — | — | — | — | — | — | — |
| ADOGEN ® 442 | — | — | 2.66 | — | — | — | — | — |
| HARTOSOFT ® 5080M | — | — | — | — | — | — | — | 2.66 |
| surfactant | | | | | | | | |

*pretreated with VARISOFT ® 222 quaternary ammonium compound by slurring 100 grams of BIODAC ® granules (12/20 mesh) with a solution of 5 grams of VARISOFT ® 222 dissolved in 70 grams isopropanol

The material in the tables above known as TALSTAR® SFR MUP synthetic pyrethroid was obtained from FMC Corporation. The materials known as EXXSOL® D-110 and AROMATIC® 200 hydrocarbon solvents are available from Exxon Chemical Company of Houston, Tex. The material known as ADOGEN® 442 quaternary ammonium compound is available from DeGussa Goldschmidt of Hopewell, Va. The material known as VARISOFT® 222 quaternary ammonium compound is available from DeGussa Goldschmidt of Hopewell, Va. The material known as CARSPRAY® 300 quaternary ammonium compound is available from DeGussa Goldschmidt of Hopewell, Va. The material known as Tall Oil Fatty Acid (TOFA L-5) was obtained from Arizona Chemical Company of Panama City, Fla.

Additional BIODAC® granules with surfactant and permethrin were made and tested against BIODAC® granules comprising permethrin with no surfactant, and also versus BIODAC® granules comprising permethrin which also contained non-surfactant liquids. Relative efficacy was established by testing the granules under controlled laboratory conditions against imported red fire ants, solenopsis invicta. Granules containing surfactant were found to be more effective than granules without surfactant.

### Preparation of BIODAC® Granule Formulations

A solution of permethrin and the surfactant or other organic liquid of choice was absorbed onto the BIODAC® 12/20 mesh granules such that the granule product contained 0.1% permethrin active ingredient and various levels of surfactant or liquid. Surfactants were used at three rates in the study to determine the effect of surfactant loading on product efficacy. The rates were 4%, 9%, and 14% by weight based on the total combined weight of the granules and all liquids present. The non-surfactant liquids were used at a rate of 14% relative to the BIODAC® granules. For comparison to the granules containing permethrin and surfactant (or liquid), a granule was prepared containing 0.1% permethrin without surfactant. This was accomplished by dissolving the permethrin technical in isopropyl alcohol, applying this solution to the BIODAC® granules, and then allowing the isopropanol to fully evaporate by exposing them to air for 48 hours. Finally, two compositions were prepared without permethrin to serve in the study as a check treatment, to confirm that the ants would remain viable under the test conditions in the absence of permethrin.

TABLE III

| | Example No. | | | | | | | | |
|---|---|---|---|---|---|---|---|---|---|
| Ingredient | 17 | 18 | 19 | 20 | 21 | 22 | 23 | 24 | 25 |
| BIODAC ® 12/20 granules | 85 | 90 | 95 | 85 | 95 | 90 | 85 | 85 | 99 |
| 10% permethrin in | 1 | 1 | 1 | 1 | 1 | 1 | — | — | 1 |
| toluene | | | | | | | | | |
| SURFONIC ® N-60 | 14 | 9 | 4 | — | — | — | — | 14 | — |
| surfactant | | | | | | | | | |
| SURFONIC ® L46-5 | — | — | — | — | 4 | 9 | 14 | — | — |
| surfactant | | | | | | | | | |
| Toluene | — | — | — | — | — | — | 1 | 1 | — |
| Dipropylene glycol | — | — | — | — | — | — | — | — | — |
| TOFA ® L-5 | — | — | — | 14 | — | — | — | — | — |

TABLE IV

| | Example No. | | | | | | | |
|---|---|---|---|---|---|---|---|---|
| Ingredient | 26 | 27 | 28 | 29 | 30 | 31 | 32 | 33 |
| BIODAC ® 12/20 granules | 85 | 85 | 85 | 95 | 95 | 90 | 85 | 90 |
| 10% permethrin in toluene | 1 | 1 | 1 | 1 | 1 | 1 | 1 | 1 |
| SURFONIC ® L46-5 surfactant | — | — | — | — | — | — | 14 | — |
| SURFONIC ® L12-6 surfactant | — | — | — | 4 | — | — | — | — |
| SURFONIC ® L12-3 surfactant | — | — | — | — | 4 | — | — | — |
| SURFONIC ® T-10 surfactant | — | — | — | — | — | 9 | — | — |
| SURFONIC ® POA L-62 | — | — | — | — | — | — | — | 9 |
| surfactant | | | | | | | | |
| Propylene carbonate | 14 | — | — | — | — | — | — | — |
| P&G CE-1270 methyl ester | — | 14 | — | — | — | — | — | — |
| Dipropylene glycol | — | — | 14 | — | — | — | — | — |

### General Procedure for the Ant Bioassay

Round aluminum pans, ¼ inch deep and 12.5 square inches in surface area were used for the tests. A glass fiber filter paper was placed on the bottom of each pan. The granules to be tested were weighed into each pan to the nearest milligram and evenly distributed over the bottom surface of the pan. The filter pad was then saturated with 3.5 grams of water and covered with a sheet of cellulose acetate. After standing 30 minutes, 20 live fire ants were introduced to the pan and covered to prevent escape. Mortality readings were taken after one, two, and four hours. Each composition was tested at two treatment rates: 30 mg (“low”) and 50 mg (“high”) per pan. Five replicates of each composition/treatment rate were done and the average mortality was then calculated in each case. The average mortality for each test case is tabled below, and is specified in terms of percentage of ants killed.

TABLE V
“low” treatment level

| | Mortality percentages | | |
|---|---|---|---|
| Sample No. | 1 hour | 2 hour | 4 hour |
| 32 | 45 | 89 | 92 |
| 22 | 52 | 66 | 84 |
| 21 | 61 | 83 | 92 |
| 17 | 41 | 77 | 89 |
| 18 | 52 | 88 | 96 |
| 19 | 14 | 40 | 67 |
| 28 | 0 | 0 | 0 |
| 20 | 0 | 0 | 0 |
| 25 | 5 | 5 | 5 |
| 23 | 0 | 0 | 0 |
| 24 | 0 | 0 | 0 |

TABLE VI
“high” treatment level

| | Mortality percentages | | |
|---|---|---|---|
| Sample No. | 1 hour | 2 hour | 4 hour |
| 32 | 69 | 84 | 91 |
| 22 | 68 | 84 | 92 |
| 21 | 52 | 83 | 84 |
| 17 | 74 | 92 | 99 |
| 18 | 69 | 87 | 92 |
| 19 | 36 | 73 | 84 |
| 28 | 3 | 5 | 4 |
| 20 | 3 | 3 | 6 |
| 25 | 0 | 0 | 0 |
| 23 | 0 | 0 | 0 |
| 24 | 0 | 0 | 0 |

TABLE VII

Mortality percentages

| Sample No. | 1 hour | 2 hour | 4 hour | Treatment Rate |
|---|---|---|---|---|
| 31 | 89 | 97 | 100 | High |
| 33 | 85 | 100 | 100 | High |
| 30 | 32 | 78 | 79 | Low |
| 29 | 82 | 95 | 100 | Low |
| 27 | 0 | 0 | 0 | High |
| 26 | 0 | 0 | 0 | High |

Thus, from comparison of the results of the ant testing, it is clear that the presence of a surfactant greatly increases the effectiveness of the insecticide.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. The present disclosure includes the subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claim so modified. This also includes combination of the features and/or limitations of one or more of the independent claims with the features and/or limitations of another independent claim to arrive at a modified independent claim, with the remaining dependent claims in their original text being read and applied to any independent claim so modified. Accordingly, the presently disclosed invention is intended to cover all such modifications and alterations, and is limited only by the scope of the claims which follow, in view of the foregoing and other contents of this specification.

What is claimed is:

1) A composition of matter useful as a pesticide which comprises:
a) 85-97% by weight of a cellulosic granular carrier;
b) 0.01-10% by weight of at least one agriculturally active ingredient;
c) 1-15% by weight of at least one surfactant,
wherein all weights percents are expressed as percentages based on the total weight of the final granular composition.

2) A composition according to claim 1, wherein said agriculturally active ingredient is an insecticide.

3) A composition according to claim 2, wherein said insecticide is a pyrethroid.

4) A composition according to claim 3, wherein said pyrethroid is selected from the group consisting of: pyrethrin and bifenthrin.

5) A composition according to claim 1, where said at least one surfactant comprises a nonionic surfactant having a melting point below 50° C.

6) A composition according to claim 1, where the surfactant (or surfactants) is a nonionic surfactant(s) selected from nonylphenol ethoxylates, fatty alcohol ethoxylates, or fatty amine ethoxylates.

7) A composition according to claim 1 further comprising: d) at least one agricultural adjuvant.

8) A method for preparing a granular composition useful as a pesticide which comprises the steps of
a) providing a cellulosic granular carrier;
b) providing at least one agriculturally active ingredient;
c) providing at least one surfactant;
d) combining said surfactant and said agriculturally active ingredient with said cellulosic granular carrier materials.

9) A method according to claim 8 in which said cellulosic granular carrier is present in any amount between about 85-97% by weight based on the total weight of all of said materials present.

10) A method according to claim 8 in which said at least one agriculturally active ingredient is present in any amount between about 0.01 to 10% by weight based on the total weight of all of said materials present.

11) A method according to claim 8 in which said at least one surfactant is present in any amount between about 1 to 15% by weight based on the total weight of all of said materials present.

12) A method according to claim 8 further comprising the step of e) providing at least one adjuvant, prior to combining said carrier with any of the ingredients selected from the group consisting of said at least one agriculturally active ingredient; and said at least one surfactant.

13) A method according to claim 8 in which the agriculturally active ingredient(s) and surfactant(s) are in liquid form when combined with said cellulosic granules.

14) A method for controlling pests by applying a composition according to claim 1 to the earth.

15) A method for controlling pests by applying a composition according to claim 1 to foliage.

16) A method for controlling pests by applying a composition according to claim 1 to the locus of a pest, where the agriculturally active ingredient is a pyrethroid, and wherein the pest is an insect.
